(19) United States
(12) Patent Application Publication
(10) Pub. No.: US 2026/0365775 A1
(43) Pub. Date: Nov. 19, 2026

(54) FLAME-RETARDANT POLYURETHANE AND USES THEREOF

(71) Applicants: CLARIANT INTERNATIONAL LTD, Muttenz (CH); FUHUA TONGDA CHEMICAL INC., Leshan (CN)

(72) Inventors: Florian CLAUSEN, Düsseldorf (DE); Oliver HAUENSTEIN, Bonn (DE); Hua ZHANG, Leshan (CN); Hsing Tie WANG, Leshan (CN); Zhou LI, Leshan (CN); Hu LIU, Leshan (CN)

(21) Appl. No.: 19/487,221

(22) PCT Filed: Mar. 25, 2024
(86) PCT No.: PCT/CN2024/083608

§ 371 Date: Nov. 24, 2025

(30) Foreign Application Priority Data
May 25, 2023 (CN) 202310599807.0
Aug. 29, 2023 (WO) PCT/CN2023/115548

(51) Int. Cl. C08G 18/08; C08G 18/18; C08G 18/22; C08G 18/24; C08G 18/42; C08G 18/48; C08G 101/00; C08K 5/5313

(52) U.S. Cl. CPC C08G 18/0838; C08G 18/14; C08G 18/1833; C08G 18/225; C08G 18/244; C08G 18/4208; C08G 18/4829; C08K 5/5313; C08G 2101/00; C08G 2110/0008; C08G 2110/0025; C08G 2110/0083

(57) ABSTRACT

A flame-retardant polyurethane obtained by reacting a polyol and an isocyanate in the presence of a flame retardant comprising a phosphinate of formula (I): wherein R1 is a hydrocarbyl radical selected from C₁-C₁₂ alkyl and C₆-C₂₀ aryl groups; and wherein R2 and R3, which are the same or different, independently denote H or a C₁-C₁₂ alkyl.

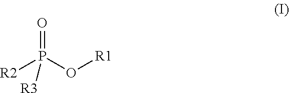

### TECHNICAL FIELD

The present invention relates to a flame-retardant polyurethane containing a particular type of phosphinate flame retardant, a process for manufacturing the same, and its uses in industry.

### BACKGROUND ART

To achieve a desirable flame retardancy for industrial uses, combustion modified polyurethanes commonly incorporate at least one type of flame retardant substance. In these application scenarios, liquid flame retardants are often preferred to their solid counterparts. This preference stems from several advantageous properties: compared to solid flame retardants, liquid flame retardants can be more easily and uniformly dispersed or even dissolved within the polymer in the blending process, thereby providing a consistent flame retardant effect throughout. Additionally, liquid flame retardants can often be processed at lower temperatures than solids, mitigating potential polymer degradation issue associated with higher temperatures. Owing to their greater surface area for interaction, these liquid additives can be incorporated into the resin mixture more rapidly than solids. Furthermore, liquid flame retardants, in general, can be handled more easily during the blending process with polyol permitting accurate dosage control and seamless integration with polymer formulations.

One popular liquid flame retardant widely used in the industry is TCPP (tris (1-chloro-2-propyl) phosphate), which is often incorporated in polyurethane foam in consumer products and in home insulation, as well as in electronics. However, despite providing an effective flame retardancy, TCPP was found to escape over time into the environment, causing negative toxicological and ecotoxicological impacts due to its halogenated nature. In addition, leaching of the TCPP flame retardant causes the overall flame retardant effectiveness to diminish over time. U.S. Pat. No. 9,631,144 B2 describes a different liquid flame retardant composition that comprises one or more halogenated flame retarding agents, which are the brominated epoxides obtained by reacting tetrabromobisphenol A with epichlorohydrin. This particular liquid flame retardant is said to provide stable incorporation into rigid polyurethane foams and shows good flame retardancy. However, it is worth noting that in the working examples provided in U.S. Pat. No. 9,631,144B2, said brominated epoxide was obtained in the resin form with a high softening point, necessitating further processing at high temperatures. Moreover, the resulting liquid flame retardant composition notably features a high bromine content of at least 30 wt %.

In view of growing concern over the use of halogenated flame retardants for environmental protection, continuous efforts have been made to find alternative non-halogenated liquid flame retardants for polymers and polymer foams.

U.S. Pat. No. 4,458,035 A describes oligomeric phosphate flame retardant for polyurethane foams, and said phosphate is of the formula (1) below in which
n is 0 to 10,
R is an C₁-C₁₀ (halo)alkyl radical and
R₁ and R₂ are hydrogen atoms or C₁-C₁₀ (halo)alkyl radicals.

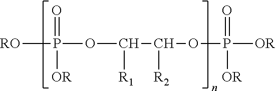

U.S. Pat. No. 7,288,577 B1 describes blends of two different phosphate flame retardants for polyurethane, consisting essentially of:
(a) 50 percent by weight, of the blend, of butylated triphenyl phosphate and
(b) 50 percent by weight, of the blend, of poly(ethylethyleneoxy) phosphate.

Although the foregoing patent disclosures may have mentioned some efficient liquid phosphorus-based flame retardants, some of them are found to be prone to hydrolysis under humid condition, which in turn leads to adverse influences on polymerization process or final polymer properties. Particularly, it is known that hydrolytically formed acid could deactivate polymerization catalyst during foaming process, and further cleave the covalent bonds in the polymer foam product, thereby destroying the intended 3-D foam network.

Several liquid phosphorus-based flame retardant products are commercially available, including Antiblaze® 1045 (from Albemarle), a cyclic phosphonate compound commonly employed in polymers like PET and PBT. The chemical structure of this cyclic phosphinate is illustrated by formula (2) below.

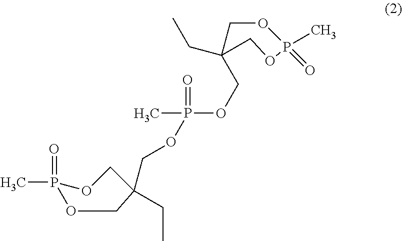

Antiblaze® 1045 exhibits a high viscosity, typically 500,000 mPa·s or higher at a temperature of 25 °C. Consequently, its effective utilization could involve careful impregnation onto a carrier material or meticulous application as an aqueous solution onto the polymer fiber surface. In the latter case, subsequent heating is necessary to achieve softening of the fiber and dissolution of the cyclic phosphonate for desired outcomes.

### SUMMARY

The object of the present invention is to provide a new non-halogenated flame retardant for use in polyurethane and in particular polyurethane foam. Said non-halogenated flame retardant adopts a liquid form at room temperature and under conventional polyurethane manufacturing conditions, has a suitably low viscosity to facilitate easy processing and handling, demonstrates exceptional hydrolytic stability even under humid conditions, and delivers an equal or enhanced level of flame retardancy to polyurethane materials compared to existing commercial standards.

The present invention aims to provide a flame-retardant polyurethane, specifically a polyurethane foam, that achieves superior flame retardant efficiency by integrating the aforementioned non-halogenated flame retardant.

The present invention provides use of a phosphinate of formula (I) as flame retardant for polyurethane

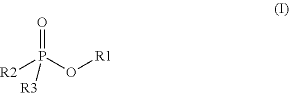

wherein R1 is a hydrocarbyl radical selected from C₁-C₁₂ alkyl and C₆-C₂₀ aryl groups;
and wherein R2 and R3, which are the same or different, independently denote H or a C₁-C₁₂ alkyl.

The present invention further provides flame-retardant polyurethane obtained by reacting a polyol and an isocyanate in the presence of a flame retardant comprising a phosphinate of formula (I).

### DETAILED DESCRIPTION

Unless otherwise indicated, the term “hydrocarbyl radical” as used herein indicates an aliphatic radical, aromatic radical, or a cycloaliphatic radical, which may be saturated or unsaturated, straight-chain or branched-chain, and optionally substituted with heteroatoms (e.g. O, N, S).

Preferably, R1 is selected from C1-C6 alkyl, more preferably from C2-C4 alkyl.

Also preferably, R2 and R3 are not H at the same time.

In one preferred embodiment of the present invention, one of R2 and R3 is H or ethyl and the other is a C1-C6 alkyl.

In another preferred embodiment of the present invention, one of R2 and R3 is methyl and the other is H or a C1-C4 alkyl.

In one particularly preferred embodiment, R1 is ethyl, one of R2 and R3 is methyl and the other is ethyl.

In another particularly preferred embodiment, R1 is butyl, one of R2 and R3 is methyl and the other is H.

In yet another particularly preferred embodiment, R1 is butyl, one of R2 and R3 is methyl and the other is butyl.

Due to its chemical nature, the phosphinate flame retardant according to the present invention adopts a liquid form at room temperature and under conventional polyurethane manufacturing conditions. Advantageously, said liquid-form phosphinate flame retardant is further characterized by a low viscosity of less than 100 mPa·s at a temperature of 25 °C, preferably less than 50 mPa·s, and more preferably less than 10 mPa·s. The viscosity may be measured by DIN 51398. As mentioned earlier in the foregoing text, the advantageous property of low viscosity could play a significant role in the practical application of a liquid flame retardant for manufacturing flame-retardant polyurethanes. The utilization of a viscous liquid flame retardant presents challenges as it typically requires heating the container, feed, and discharge pipes involved in the storage or transport of the liquid. Moreover, attaining homogeneous incorporation of a highly viscous flame retardant liquid into a polymer composition often requires additional efforts, especially in scaled-up industrial processes for large-volume chemical production.

The phosphinate of formula (I) may be prepared by different methods. One approach is to react α-monoolefins with (alkyl)phosphinates in the presence of free-radical generators, as described in US 39 14 345 A, EP 23 73 666 A1, US 87 35477 B2 and EP 2367 834 A1.

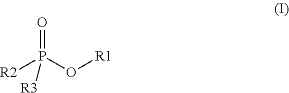

The phosphinate of formula (I) may also be prepared from its corresponding phosphite by a catalytic rearrangement reaction. For instance, one corresponding phosphite is of structure (II) below:

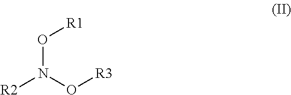

As illustrated in Synthetic Example 1, this preparation process may be realized by a two-step method. In the first step, one corresponding phosphite for the desired phosphinate product is produced as an intermediate product, while in the second step, this intermediate product is subjected to a catalytic rearrangement reaction, to obtain a phosphinate of formula (I). Alternatively, if the corresponding phosphite is readily available from the chemical market, the preparation process can be streamlined into a single-step reaction.

The rearrangement catalyst in this preparation process may be an iodine-containing catalyst and a Lewis acid catalyst, such as iodine, alkyl iodine and alkali-metal iodized salt (especially potassium iodide) as described in CN 104693238A. Alternatively, the rearrangement catalyst may be sodium iodide as described in CN 109400643A.

Advantageously, the rearrangement catalyst may be a small organic molecule sulfonate, and more advantageously selected from a group consisting of diethyl sulfate, ethyl ethanesulfonate, p-toluenesulfonic-acid methyl ester, p-toluenesulfonic-acid ethyl ester, p-chlorobenzenesulfonic-acid methyl ester and p-chlorobenzenesulfonic-acid ethyl ester. The benefits of using a small organic molecule sulfonate rearrangement catalyst in this preparation process include cost-effectiveness and simplified catalyst recovery, among others.

When either R2 or R3 is H, the phosphinate of formula (I) may be prepared by reacting an alkyldichlorophosphine with an alcohol at moderate temperatures, as illustrated in Synthetic Example 2. This reaction, known as alcoholysis, results in partial oxidation of the phosphine, leading to the formation of the corresponding alkyl phosphinate ester while yielding one P—H bond.

One illustrative example of this chemistry is presented in CN 113493478A, where methyldichlorophosphine is reacted with n-butanol at room temperature. The reaction yields n-butyl methyl phosphinate as the desired product, along with the formation of hydrogen chloride and n-butyl chloride as side-products. The present invention also provides a flame-retardant polymer obtained by reacting monomers in the presence of a flame retardant comprising a phosphinate of formula (I), under polymerization conditions.

The flame-retardant polyurethane (PUR) of the present invention is a polyurethane composition comprising a phosphinate of formula (I) as flame retardant. In one embodiment of said polyurethane composition, the phosphinate of formula (I) is present in an amount ranging from 0.5% to 30% by weight, relative to the weight of the polyurethane. Preferably, the phosphinate of formula (I) is present in an amount ranging from 0.5% to 20% by weight, relative to the weight of the polyurethane.

The flame-retardant polyurethane of the present invention is preferably obtained by reacting a polyol and an isocyanate in the presence of a flame retardant comprising a phosphinate of formula (I), optionally in the presence of a polymerization catalyst. Suitable polymerization catalysts for the production of the flame-retardant polyurethane may be selected from aliphatic tertiary amines (for example, triethylamine, tetramethylbutanediamine), cycloaliphatic tertiary amines (for example, 1,4-diaza(2,2,2)bicyclooctane), aliphatic aminoethers (for example, dimethylaminoethyl ether and N,N,N-trimethyl-N-hydroxyethyl-bisaminoethyl ether), cycloaliphatic aminoethers (e.g. N-ethylmorpholine), aliphatic amidines, cycloaliphatic amidines, urea, derivatives of urea (such as aminoalkyl ureas, see for example EP-A 0 176 013, in particular (3-dimethylaminopropylamine) urea), and tin catalysts (such as dibutyltin oxide, dibutyltin dilaurate, tin octoate).

One notable advantage of using the phosphinate of formula (I) as flame retardant for polyurethane is its high compatibility with polyols, i.e. one essential starting material of polyurethane. The phosphinate of formula (I) can easily dissolve in polyols, forming a homogeneous solution that remains stable for extended periods of time during storage or transportation. This homogeneous solution serves as a beneficial starting material for polymerization, ensuring the resulting polyurethane product has a consistently distributed flame retardancy throughout.

The present invention provides a process for manufacturing a flame-retardant polyurethane, comprising preparing a mixture comprising a polyol and a flame retardant comprising a phosphinate of formula (1); and adding an isocyanate compound into the mixture.

For the purpose of the present invention, the term “polyol” refers to compounds having at least two hydrogen atoms capable of reaction with isocyanates. These are compounds having amino groups, thio groups or carboxyl groups, and preferably compounds having hydroxyl groups, in particular from 2 to 8 hydroxyl groups.

Suitable polyols for the purpose of the present invention include those having a molecular weight (Mw) of from 400 to 10,000, specifically those of molecular weight from 1000 to 6000, preferably from 2000 to 6000, and are generally polyethers or polyesters dihydric to octahydric, preferably dihydric to hexahydric, or else polycarbonates or polyesteramides, as known per se for the production of homogenous or of cellular polyurethanes, and as described in DE-A 28 32 253, for example.

Preferred polyester polyols are obtained by polycondensation of a polyalcohol such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, glucose and/or sorbitol, with a dibasic acid such as oxalic acid, malonic acid, succinic acid, tartaric acid, adipic acid, sebacic acid, maleic acid, fumaric acid, phthalic acid and/or terephthalic acid. These polyester polyols can be used alone or in combination.

For production of thermoset flame-retardant polyurethane, a further preferred group of polyester polyols are those with two, three or four hydroxyl groups, including ethylene glycol, propylene glycol, trimethylolpropane and pentaerythritol. Preferred polyether polyols include, but are unlimited to, triols such as glycerol, trimethylolethane (i.e., 1,1,1-tris(hydroxymethyl)ethane), and trimethylolpropane (i.e., 1,1,1-tris(hydroxymethyl)propane); tetraols such as pentaerythritol; pentaols such as glucose; hexaols such as dipentaerythritol and sorbitol; or alkoxylated derivatives of all the above polyalcohols, such as preferably, ethoxylated and propoxylated derivatives thereof.

A particularly preferred polyether polyol is a polyoxypropylene triol.

Other suitable polyols for the purpose of the present invention include those having a low molecular weight from 30 to 400, which are preferably compounds having hydroxyl groups and/or amino groups and serving as chain extenders or crosslinkers. These compounds generally have from 2 to 8, preferably from 2 to 4, hydrogen atoms capable of reaction with isocyanates.

Suitable isocyanate used for producing the flame-retardant polyurethane of the present invention may be selected from, e.g., aliphatic, cycloaliphatic, araliphatic, aromatic or heterocyclic polyisocyanates (see, for example, W. Siefken in Justus Liebigs Annalen der Chemie, 562, pp. 75-136), for example those of the formula Q(NCO)ᵣ, where r is from 2 to 4, preferably from 2 to 3, and Q is an aliphatic hydrocarbyl radical having from 2 to 18 carbon atoms, preferably from 6 to 10 carbon atoms, a cycloaliphatic hydrocarbyl radical having from 4 to 15 carbon atoms, preferably from 5 to 10 carbon atoms, an aromatic hydrocarbyl radical having from 6 to 15 carbon atoms, preferably from 6 to 13 carbon atoms, or an araliphatic hydrocarbyl radical having from 8 to 15 carbon atoms, preferably from 8 to 13 carbon atoms.

Suitable polyisocyanates for the purpose of the invention are aromatic, alicyclic and/or aliphatic polyisocyanates having at least two isocyanate groups and mixtures thereof. Preference is given to aromatic polyisocyanates such as tolyl diisocyanate, methylene diphenyl diisocyanate, naphthylene diisocyanate, xylylene diisocyanate, tris(4-isocyanatophenyl)methane and polymethylene-polyphenylene diisocyanates; alicyclic polyisocyanates such as methylenediphenyl diisocyanate, tolyl diisocyanate; aliphatic polyisocyanates and hexamethylene diisocyanate, isophorone diisocyanate, dimeryl diisocyanate, 1,1-methylenebis(4-isocyanatocyclohexane-4,4′-diisocyanatodicyclohexylmet and isomer mixture, 1,4-cyclohexyl diisocyanate, and lysine diisocyanate and mixtures thereof.

Particular preference is generally given to the polyisocyanates readily available in industry, such as 2,4- and 2,6-toluene diisocyanate, and methylene diphenyl isocyante (MDI) or polymeric form thereof (pMDI).

For the purpose of the present invention, the flame-retardant polyurethanes may be linear PUR, e.g., produced by diols and diisocyanates, or crosslinked PURs, e.g. produced by converting triisocyanate diisocyanate mixtures with triol-diol mixtures. The properties of flame-retardant polyurethanes can be varied in a wide range. Depending on the degree of crosslinking and/or isocyanate or OH component used, thermosets, thermoplastics or elastomers are obtained.

The flame-retardant polyurethanes of the present invention may be flame-retardant polyurethane foams used as soft or hard foam, or alternatively as molding compounds for molding, as casting resins (isocyanate resins), as (textile) elastic fibers, polyurethane coatings and as polyurethane adhesives.

The present invention also provides a flame-retardant polyurethane foam obtained by reacting a polyol and an isocyanate in the presence of a flame retardant comprising a phosphinate of formula (I), further in the presence of a blowing agent, a foaming catalyst, a foam stabilizer, and optionally other additives.

In one preferred embodiment of the present invention, the invented flame-retardant polyurethane foam is a flexible foam.

In another preferred embodiment of the present invention, the invented flame-retardant polyurethane foam is a rigid foam.

For the purpose of the present invention, the term “blowing agent” refers to a substance which is capable to provide gas and produce a foam of cellular structure in the polyol-isocyanate reaction. Any conventional blowing agents for the production of polyurethane foams are suitable for use here, including physical blowing agents and chemical blowing agents. Examples of physical blowing agents include butane and carbon dioxide, which expand at a reduced pressure, as well as short-chain (C₅-C₆) aliphatic molecules such as pentane or cyclopentane and various hydrofluoroolefins such as 1,3,3,3-tetrafluoropropen, which are low-boiling-point liquids. Examples of chemical blowing agents include water and carboxylic acids, which release gas when reacting with isocyanate. A particular preferred blowing agent is water.

For the purpose of the present invention, suitable foaming catalyst for the production of the invented flame-retardant polyurethane foam are preferably selected from amine catalysts (e.g. tertiary amines) and organometallics (e.g. stannous octoate, stannous acetate, dibutyltin diacetate, etc.).

For the purpose of the present invention, suitable foam stabilizers for producing flame-retardant polyurethane foams may be any conventional stabilizers for controlling and stabilizing polyurethane foams. As one preferred example, said stabilizer may be selected from silicone surfactants.

For the production of a flame-retardant polyurethane foam according to the present invention, other additives may be added to the reactant mixtures, including fillers, pigments, light stabilizers, and processing aids.

The invention furthermore relates to the use of the flame-retardant polyurethane or flame-retardant polyurethane foam as aforementioned for the manufacture of doorliners, headliners, seat covers, high-resilience foam seating, high-resilience foam mattresses rigid foam insulation panels, viscoelastic foam mattrasses, potting foam for battery applications, microcellular foam seals and gaskets, durable elastomeric wheels and tires, automotive suspension bushings, electrical potting compounds, high-performance adhesives, surface coatings and sealants, synthetic fibers, carpet underlay, hard-plastic parts and hoses.

The invention also relates to the use of the flame-retardant polyurethane or flame-retardant polyurethane foam for the manufacture of electrical switch components, components in automobile construction, electrical engineering or electronics, printed circuit boards, prepregs, potting compounds for electronic components, in boat and rotor blade construction, in outdoor GFRP applications, domestic and sanitary applications and engineering materials.

### EXAMPLES

Hereinafter, the present invention is described in more detail and specifically with reference to the Examples, which however are not intended to limit the present invention.

### 1. Components Used

### Flame Retardant:

FR-1: ethyl ethyl(methyl)phosphinate (MEPE) product of Synthetic Example 1
FR-2: butyl methylphosphinate product of Synthetic Example 2
FR-3: butyl butyl(methyl)phosphinate (MUPU) product of Synthetic Example 3
Ref-1: Fyrol® PCF from ICL Industrial Products, TCPP (tris (1-chloro-2-propyl) phosphate), a halogenated phosphate ester
Ref-2: Exolit® OP 550 from Clariant International Ltd, a non-halogenated, polymeric phosphorus polyol specifically designed for flexible polyurethane foams, which is a phosphate ester with hydroxyalkyl groups.

### Polyol:

Polyether polyol (P1): Arcol® 1104 or 1108 from Covestro AG, a medium molecular weight polyoxypropylene triol with an OH number of 56 mg KOH/g
Polyester polyol (P2): Terate® HT 5510, an aromatic polyester polyol from Stepan Company with a hydroxyl number of 257 mg KOH/g

### Polymerization Catalyst:

Cat 1: Kosmos® EF from Evonik Industries, a stannous catalyst
Cat 2: Kosmos® 29 from Evonik Industries, a stannous octoate catalyst
Cat 3: Niax® A1 from Momentive Performance Materials Inc., an amine catalyst based on bis(2-dimethylaminoethyl)ether
Cat 4: Tegoamin® 33 from Evonik Industries, an amine catalyst based on triethylenediamine
Cat 5: JEFFCAT® ZF-10 from Huntsman, an amine catalyst based on N,N,N′-trimethyl-N′-hydroxyethylbisaminoethylether
Cat 6: Polycat 5 from Evonik Industries, an amine catalyst based on bis(2-dimethylaminoethyl)methylamine.
Cat 7: Kosmos 75 MEG from Evonik Industries, a foam catalyst based on low-viscous potassium octoate

### Foam Stabilizer:

S1: Tegostab® B 8232 from Evonik Industries, a silicone surfactant
S2: Tegostab® B 8522 from Evonik Industries, a silicone surfactant TDI (tolyl diisocyanate):
T80: Desmodur® T80 from Covestro AG, 2,4- and 2,6-toluene diisocyanate, 80/20 mixture of isomers

### MDI (Methylene Diphenyl Diisocyante):

MDI1: Desmodur® 44 V 70 L from Covestro AG is a mixture of diphenylmethane-4,4′-diisocyanate (MDI) with isomers and higher functional homologues (PMDI).

### 2. Synthetic Examples for Inventive Flame Retardants FR-1, FR-2 and FR-3

### 2.1. Synthetic Example 1: Production of FR-1

### Step 1: Production of Diethyl Methylphosphonite

In a 25 L autoclave equipped with a thermometer and condenser, a mixture of 5280 g of petroleum ether, 413 g of absolute ethanol and 1100 g of triethylamine was added. The reaction system was purged with nitrogen three times, and then a solution of 501 g of methyldichlorophosphane were added dropwise at a temperature of 25 °C. Once the addition is completed, the temperature was maintained at 25 °C for 30 minutes.

The resulting reaction mixture was then subjected to the pressure filtration to remove the generated NEts-HCl. The resulting filter cake was washed with 1000 mL of petroleum ether. Subsequently, the filtrate, weighing 6590 g, was subjected to distillation to recover the petroleum ether and obtain the crude product of diethyl methylphosphonite.

Finally, 557.8 g of diethyl methylphosphonite were obtained through rectification. The purity detected by gas chromatography (GC) was 98.5%, resulting in a yield of 96.1%.

### Step 2: Production of ethyl ethyl(methyl)phosphinate (FR-1)

In a 1 L three-necked flask equipped with a thermometer and condenser, a mixture of 557.0 g diethyl methylphosphonite and 27.50 g p-toluenesulfonate was added. The flask was then purged with N2. The temperature was gradually increased, and the reaction mixture was vigorously stirred and refluxed. The oil temperature slowly rose from 120 °C to 170 °C before insulation. After 9 hours, no significant reflux was observed (raw material detected by GC was less than 0.5%), indicating completion of the reaction.

Finally, 535.0 g of FR-1 product with a viscosity of 3.5 mPa·s was obtained by vacuum distillation (2 to 3 kPa, 101 °C). The purity of the product, as determined by GC, was 98%, resulting in a yield of 98%.

### 2.2. Synthetic Example 2: Production of FR-2

Methyldichlorophosphane was continuously fed into a vaporizer at a flow rate of 119.39 g/h. The vaporized methyldichlorophosphane was then transferred to the tower continuous reactor using a nitrogen flow at a rate of 80 ml/min.

Simultaneously, 99.5% n-butanol was introduced into another vaporizer at a rate of 243 g/h. The vaporized butanol was purged into the tower reactor using nitrogen flow, also at a rate of 80 ml/min. Subsequently, the vaporized methyldichlorophosphane and n-butanol were rapidly reacted in a tower reactor. The resulting light fraction of chloro-butane, generated by the rapid reaction, was condensed and collected to a low boiling substance receiving bottle. The heavy fraction of crude butyl methylphosphinate, generated during the reaction process, was collected into a separate receiving bottle and subsequently neutralized with triethylamine.

After neutralization, n-butanol was removed by vacuum distillation. The process yielded 96.0% butyl methylphosphinate with a viscosity of 3.4 mPa·s and a purity of 98.5%, obtained through rectification.

### 2.3. Synthetic Example 3: Production of FR-3

### Step 1: Production of dibutyl methylphosphonite

In a 25 L autoclave equipped with a thermometer and condenser, a mixture of 6200 g of petroleum ether, 674 g of absolute n-butanol and 910 g of triethylamine was added. The reaction system was purged with nitrogen three times, and then a solution of 507 g of methyldichlorophosphane were added dropwise at a temperature of −10 °C. Once the addition is completed, the temperature was maintained at 0 °C for 30 minutes.

The resulting reaction mixture was then subjected to the pressure filtration to remove the generated NEt₃·HCl. The resulting filter cake was washed with 1000 mL of petroleum ether. Subsequently, the filtrate, weighing 7506 g, was subjected to distillation to recover the petroleum ether and obtain the crude product of dibutyl methylphosphonite.

Finally, 756.7 g of dibutyl methylphosphonite were obtained through rectification. The purity detected by gas chromatography (GC) was 95%, resulting in a yield of 88%.

### Step 2: Production of butyl butyl(methyl)phosphinate (FR-3)

In a 1 L three-necked flask equipped with a thermometer and condenser, a mixture of 600 g dibutyl methylphosphonite and 30 g p-toluenesulfonate was added. The flask was then purged with N₂. The temperature was gradually increased, and the reaction mixture was vigorously stirred and slightly refluxed. The oil temperature slowly rose from 150 °C to 180 °C before insulation. After 6 hours, the raw material detected by GC was less than 0.5%, indicating completion of the reaction.

Finally, 571 g of FR-3 product with a viscosity of 6.4 mPa·s was obtained by vacuum distillation (0.2-0.3 kPa, 86 °C). The purity of the product, as determined by GC, was 98%, resulting in a yield of 98.0%.

### 3. Hydrolytic Stability Comparative Test

The hydrolytic stability provided by different flame retardants was compared by measuring the acid value of polyol blends containing flame retardant and water over time during storage at an elevated temperature. For this purpose, 90 g of polyol, 9 g of flame retardant and 4.5 g of water were homogenized by stirring at 1500 rpm for 2 minutes. The acid value was then determined using a 3:1 (v/v) isopropanol/water mixture as solvent and 0.1 N NaOH (aq.) solution as titration agent. The samples were then stored at 40 °C and the acid values determined after 11, 17 and 28 days. Samples were homogenized before analysis by stirring at 1500 rpm for 2 minutes. The acid value development of polyol-water blends without flame retardant addition was also determined after 11 and 28 days, respectively, as shown in Table 1.

TABLE 1
Hydrolytic stability comparison: evaluation of the
acid value of polyol blends containing flame retardant
and water over time during storage at 40 °C

| | | | Acid value (mg KOH/g) | | |
|---|---|---|---|---|---|
| | Polyol | Flame retardant | 11 d | 17 d | 28 d |
| Polyether | P1 | — | 0 | — | 0.1 |
| blend | P1 | FR-1 | 0.1 | 0.2 | 0.2 |
| | P1 | Ref-2 | 43.2 | 45.4 | 47.1 |

Compared to the flame-retardant-free reference, the inventive example FR-1 did not cause a notable increase of acid value in their polyol blends, during and after the entire 28 days of storage under 40 °C. This indicates a high hydrolytic stability of FR-1 during storage in the polyol blend, namely zero to negligible hydrolysis of the FR-1. In comparison, the acid value of polyol blend containing Ref-2 significantly increased after merely 11 days under the same storage condition, which can only be explained by hydrolysis of Ref-2.

### 4. Viscosity Comparison of Polyol-Flame Retardant Mixtures

As aforementioned, the viscosity of the inventive liquid flame retardant is advantageously low, which facilitates easy processing and handling in the industrial application. In the synthetic examples provided, both FR-1 and FR-2 have a viscosity below 5 mPa·s, FR-3 has a viscosity below 7 mPa·s, while TCPP (Ref-1) typically has a viscosity ten times higher (60-70 mPa·s) at room temperature, as measured by DIN 51398.

In Table 2 below, a comparison is made between the viscosity of neat polyol (P2) and mixtures of polyol (P2) with flame retardants (FR-1, FR-2, FR-3 or Ref-1). The polyol-flame retardant mixtures were prepared by combining polyol P2 with a specific flame retardant (FR-1, FR-2, FR-3 or Ref-1) in a weight ratio of 89.5:10.5 at room temperature. The mixtures were thoroughly blended using a mechanical stirrer at 1000 rpm for 1 minute to ensure homogeneity. The dynamic viscosity of the neat polyol and the polyol-flame retardant mixtures was then measured according to DIN 51398.

TABLE 2
Viscosity at room temperature for neat Polyol
and Polyol-flame retardant mixture

| Sample composition | Viscosity (mPa · s) |
|---|---|
| P2 (neat) | 3547 |
| P2 & Ref-1 | 2625 |
| P2 & FR-1 | 1332 |
| P2 & FR-2 | 1072 |
| P2 & FR-3 | 1238 |

From the data of Table 2, it was observed that the inventive liquid flame retardants possess an additional advantage over conventional liquid retardants, such as TCPP (Ref-1), in effectively reducing the viscosity of polyol-flame retardant mixture during the blending process. This advantageous characteristic, when employed in polymer manufacturing, can further enhance the overall processibility.

### 5. Flexible Polyurethane (PUR) Foam Formulations with Performance Testing

Stannous catalysts, polyol, flame retardant, water, foam stabilizer and amine catalysts were weighed into a dry beaker in that order and premixed for 60 seconds at 500 rpm (for polyether polyol formulations) or 1000 rpm (for polyester polyol formulations), respectively. After addition of TDI, the mixtures were stirred at 2500 rpm for 7 seconds. The resulting mass was rapidly poured into a paper-lined box mold (25*26*26 cm). Rise time and further observations were noted during the foaming process. The foams were cured at room temperature for approximately 16 hours before cutting and collected in each comparative (C1-C3) or inventive (I1-I2) example for further evaluation.

The selection of polymerization catalyst, foam stabilizer and TDI for each foam example was made based on existing empirical guidance for optimal foamability in each case, with details listed below in Table 3.

TABLE 3
Polyol, flame retardant, catalyst, foam stabilizer
& TDI for each PUR foam example

| | Example | | | | |
|---|---|---|---|---|---|
| Component | C1 | C2 | C3 | I1 | I2 |
| Polyol | P1 | P1 | P1 | P1 | P1 |
| Flame Retardant | 0 | Ref-1 | Ref-1 | FR-1 | FR-2 |
| Polymerization | Cat 2 | Cat 2 | Cat 2 | Cat 1 | Cat 1 |
| Catalyst | Cat 3 | Cat 3 | Cat 3 | Cat 5 | Cat 5 |
| (weight ratio) | Cat 4 | Cat 4 | Cat 4 | (2:1) | (2:1) |
| | (3:2:4) | (2:1:2) | (1.3:1:2) | | |
| Foam Stabilizer | S1 | S1 | S1 | S1 | S1 |
| TDI | T80 | T80 | T80 | T80 | T80 |

### Evaluation of Flame Retardancy for Flexible Foams (FMVSS 302)

The efficiency of the flame retardants was evaluated by testing the burning behavior of flexible polyurethane foam samples with a target density of 30 kg/m³, containing the flame retardants in the horizontal burn test, as described in the Federal Motor Vehicle Safety Standard 302 (FMVSS 302). Foam density in the examples was measured according to DIN 53420. According to this standard, samples are given the highest classification (SE, “self-extinguishing”) if the flame does not travel beyond a 38 mm mark on the specimen but extinguishes within this distance. Lower classifications include SE/NBR (self-extinguishing/no burn rate), SE/B (self-extinguishing/burn rate) and B (burn rate). Five sample specimens were cut from each foam and submitted to the test. The lowest-rated specimen determined the overall classification for the foam.

The flame retardancy of tested flexible foam examples are compared in Table 4.

TABLE 4
Performance data of flexible polyurethane
polyether (P1) foam formulations

| | Example | | | | |
|---|---|---|---|---|---|
| Component* | C1 | C2 | C3 | I1 | I2 |
| P1 | 100 | 100 | 100 | 100 | 100 |
| Ref-1 | 0 | 12 | 8 | 0 | 0 |
| FR-1 | 0 | 0 | 0 | 4 | 0 |
| FR-2 | 0 | 0 | 0 | 0 | 4 |
| Catalyst | 0.45 | 0.50 | 0.43 | 0.44 | 0.45 |
| Water | 3.5 | 4.0 | 3.2 | 3.5 | 3.5 |
| Foam Stabilizer | 1.3 | 1.3 | 1.3 | 0.7 | 0.7 |
| TDI | 43.7 | 48.4 | 40.3 | 44.49 | 46.92 |
| Density [kg/m³] | 32.1 | 29.8 | 32.5 | 28.6 | 30.1 |
| FMVSS 302 rating | B | SE | SE/NBR | SE | SE |

*Amounts of all components are given in parts per 100 parts of polyol (php) by weight.

As shown in the performance data listed in Table 4, comparative example C1 (polyether polyurethane foam without flame retardant additive) does not meet the required flame retardancy standard. With 12 php of halogenated reference flame retardant TCPP (Ref-1), the comparative example C2 provides a polyether polyurethane foam which meets required flame retardancy. When the amount of flame retardant was attempted to be reduced to 8 php TCPP, as shown in Comparative Example C3, it was found that the amount of flame retardant was insufficient, and the resulted foam did not achieve the optimal flame retardancy (SE).

The inventive example I1 demonstrates the efficacy of an inventive non-halogenated flame retardant (FR-1) in achieving optimal flame retardancy standard for a polyether polyurethane foam, even at a low loading of just 4 php.

The inventive example 12, a polyether polyurethane foam with 4 php of an inventive non-halogenated flame retardant (FR-2), exhibits an equally outstanding flame retardancy rating as I1.

### 6. Rigid Polyisocyanurate (PIR) Foam Formulations with Performance Testing

Octoate catalyst, polyol, flame retardants, water, foam stabilizer and amine catalysts were weighed into a dry beaker in that order and premixed for 50 seconds at 1000 rpm. After addition of n-pentane the mixtures were stirred at 1000 rpm for 10 seconds to incorporate it into the mixture. MDI was added to the mixture subsequently, and the liquids were mixed for 7 seconds at 2500 rpm. The resulting mass was rapidly poured into a paper-lined box mold (25*26*26 cm). Rise time and further observations were noted during the foaming process. The foams were cured at room temperature for approximately 16 hours before cutting and collected in each comparative (C4-C6) or inventive (I3-I4) example for further evaluation.

The selection of polymerization catalyst, foam stabilizer and MDI for each rigid foam example was made based on existing empirical guidance for optimal foamability in each case, with details listed below in Table 5.

TABLE 5
Polyol, flame retardant, catalyst, foam
stabilizer and MDI used for PIR foam example

| Example | | | | | | |
|---|---|---|---|---|---|---|
| Component | C4 | C5 | C6 | I3 | I4 | I5 |
| Polyol | P2 | P2 | P2 | P2 | P2 | P2 |
| Flame Retardant | 0 | Ref-1 | Ref-1 | FR-1 | FR-2 | FR-3 |
| Polymerization | Cat 6 | Cat 6 | Cat 6 | Cat 6 | Cat 6 | Cat 6 |
| Catalyst | Cat 7 | Cat 7 | Cat 7 | Cat 7 | Cat 7 | Cat 7 |
| (weight ratio) | (1:6) | (1:6) | (1:6) | (1:6) | (1:6) | (1:6) |
| Foam Stabilizer | S2 | S2 | S2 | S2 | S2 | S2 |
| MDI | MDI1 | MDI1 | MDI1 | MDI1 | MDI1 | MDI1 |

Flame retardancy evaluation method for rigid foams (DIN4102-1) DIN4102-1 classifies the building materials according to their flammability. The valid norm is differentiated into two fire protection classes. ‘A’ stands for non-flammable and ‘B’ for flammable materials. Class B is relevant for polyurethane foams such as PIR-insulation panels. This is then subdivided into the following levels: B1=low flammability; B2=normal flammability; B3=high flammability. As a reference, most construction foam systems in spray-cans sold in Germany correspond to the building material class B2. The main criteria for classification of flammability class B2 is the flame height in the vertical burning test, which needs to stay below a maximum of 150 mm, which is an ideal guideline for benchmarking the flame retardancy of construction materials.

The flame retardancy of different rigid PIR foam samples was evaluated using DIN4102-1, listed in Table 6 below.

TABLE 6
Performance data of rigid polyisocyanurate polyester (P2) foam formulations

| Example | | | | | | |
|---|---|---|---|---|---|---|
| Component* | C4 | C5 | C6 | I3 | I4 | I5 |
| P2 | 100 | 100 | 100 | 100 | 100 | 100 |
| Ref-1 | 0 | 15 | 12 | 0 | 0 | 0 |
| FR-1 | 0 | 0 | 0 | 12 | 0 | 0 |
| FR-2 | 0 | 0 | 0 | 0 | 12 | 0 |
| FR-3 | 0 | 0 | 0 | 0 | 0 | 12 |
| Catalyst | 3.5 | 3.5 | 3.5 | 3.5 | 3.5 | 3.5 |
| Water | 0.7 | 0.7 | 0.8 | 0.8 | 0.7 | 0.8 |
| n-Pentane | 22 | 22 | 22 | 22 | 22 | 22 |
| Foam Stabilizer | 2.0 | 2.0 | 2.0 | 2.0 | 2.0 | 2.0 |
| MDI1 | 232.8 | 232.8 | 232.8 | 232.8 | 232.8 | 232.8 |
| Density [kg/m3] | 38.8 | 38.2 | 37.8 | 37.6 | 38.1 | 37.9 |
| DIN4102-1 rating/ | B3/> 150 | B2/120 | B3/> 150 | B2/90 | B2/100 | B2/90 |
| burning distance | | | | | | |
| [mm] | | | | | | |

*Amounts of all components are given in parts per
100 parts of polyol (php) by weight.

As shown in the performance data listed in Table 6, comparative example C4 (PIR foam without flame retardant additive) fails to meet the desired flame retardancy standard rating B2. By incorporating 15 php of halogenated reference flame retardant TCPP (Ref-1), the comparative example C5 represents a rigid PIR foam with a desired flame retardancy rating. However, when attempting to reduce the amount of this halogenated flame retardant to 12 php TCPP, as demonstrated in comparative example C6, it was observed that this decreased level of flame retardant was insufficient, resulting in the foam failing to attain the desired flame retardancy rating.

The inventive example I3 demonstrates the exceptional flame retardancy achieved by incorporating the same level of 12 php of the invented non-halogenated flame retardant FR-1 into the rigid PIR foam, meeting the optimal flame retardancy standard.

Similarly, the inventive examples I4 and I5 achieve an equally outstanding flame retardancy rating by replacing FR-1 with FR-2 or FR-3, respectively at the same level as in I3. This further highlights the effectiveness of the inventive non-halogenated flame retardants in attaining the desired flame retardancy levels in rigid foams.

1. A flame-retardant polyurethane obtained by reacting a polyol and an isocyanate in the presence of a flame retardant comprising a phosphinate of formula (I): 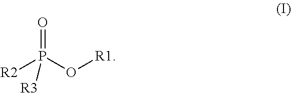
wherein R1 is a hydrocarbyl radical selected from C₁-C₁₂ alkyl and C₆-C₂₀ aryl groups;
and wherein R2 and R3, which are the same or different, independently denote H or a C₁-C₁₂ alkyl.

2. The flame-retardant polyurethane according to claim 1, wherein R1 is selected from C1-C6 alkyl, preferably from C2-C4 alkyl.

3. The flame-retardant polyurethane according to claim 1, wherein R2 and R3 are not H at the same time.

4. The flame-retardant polyurethane according to claim 3, wherein one of R2 and R3 is H or ethyl and the other is a C1-C6 alkyl.

5. The flame-retardant polyurethane according to claim 3, wherein one of R2 and R3 is methyl and the other is H or a C1-C4 alkyl.

6. The flame-retardant polyurethane according to claim 1, wherein R1 is ethyl, one of R2 and R3 is methyl and the other is ethyl.

7. The flame-retardant polyurethane according to claim 1, wherein R1 is butyl, one of R2 and R3 is methyl and the other is H.

8. The flame-retardant polyurethane according to claim 1, wherein R1 is butyl, one of R2 and R3 is methyl and the other is butyl.

9. A flame-retardant polyurethane foam obtained by reacting a polyol and an isocyanate in the presence of the flame retardant as defined in claim 1, further in the presence of a blowing agent, a foaming catalyst and a foam stabilizer.

10. The flame-retardant polyurethane foam according to claim 9, wherein the polyurethan foam is a flexible foam.

11. The flame-retardant polyurethane foam according to claim 9, wherein the polyurethan foam is a rigid foam.

12. Use of the flame-retardant polyurethane according to claim 1, for the manufacture of doorliners, headliners, seat covers, high-resilience foam seating, high-resilience foam mattresses rigid foam insulation panels, viscoelastic foam mattrasses, potting foam for battery applications, microcellular foam seals or gaskets, durable elastomeric wheels or tires, automotive suspension bushings, electrical potting compounds, high-performance adhesives, surface coatings or sealants, synthetic fibers, carpet underlay, hard-plastic parts or hoses.

13. A process for manufacturing the flame-retardant polyurethane according to claim 1, comprising:
preparing a mixture comprising a polyol and the flame retardant; and
adding an isocyanate compound into the mixture.

14. (canceled)

15. A flame-retardant polyurethane composition comprising a phosphinate of formula (I) as flame retardant 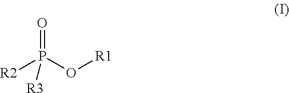
wherein R1 is a hydrocarbyl radical selected from C₁-C₁₂ alkyl and C₆-C₂₀ aryl groups;
and wherein R2 and R3, which are the same or different, independently denote H or a C₁-C₁₂ alkyl.

16. Use of the flame-retardant polyurethane foam according to claim 9, for the manufacture of doorliners, headliners, seat covers, high-resilience foam seating, high-resilience foam mattresses rigid foam insulation panels, viscoelastic foam mattrasses, potting foam for battery applications, microcellular foam seals or gaskets, durable elastomeric wheels or tires, automotive suspension bushings, electrical potting compounds, high-performance adhesives, surface coatings or sealants, synthetic fibers, carpet underlay, hard-plastic parts or hoses.
